(19) United States
(12) Patent Application Publication
(10) Pub. No.: US 2025/0363452 A1
(43) Pub. Date: Nov. 27, 2025

(54) SYSTEM AND METHOD FOR PERFORMING AN AGRICULTURAL PROCESS IN LINE WITH AN INSURANCE POLICY BY OPERATING AN AGRICULTURAL WORKING MACHINE BY A CUSTOMER

(71) Applicant: CLAAS Omaha Inc., Omaha, NE (US)

(72) Inventors: Reinhard Hesse, Versmold (DE); Patricio Frangella, Columbus, IN (US); Jordan Hellbusch, Omaha, NE (US); Ray Ochsner, Papillion, NE (US); Jeff Tilden, Columbus, IN (US); Mark Turnis, Treynor, IA (US); Scott Wellensiek, Harsewinkel (DE); Christoph Tetzlaff, Omaha, NE (US); Robin Monkenbusch, Rheda-Wiedenbrück (DE); Adam Lee Haworth, Louisville, NE (US)

(73) Assignee: CLAAS Omaha Inc., Omaha, NE (US)

(21) Appl. No.: 19/294,186

(22) Filed: Aug. 7, 2025

Related U.S. Application Data
(63) Continuation of application No. PCT/IB2023/061309, filed on Nov. 9, 2023.

(30) Foreign Application Priority Data
Feb. 9, 2023 (DE) 10 2023 103 208.9

(51) Int. Cl. G06Q 10/0875

(52) U.S. Cl. CPC G06Q 10/0875

(57) ABSTRACT

A method and system for performing an agricultural process in line with an insurance policy. An agricultural working machine is operated by a customer. A digital service module, which may be hosted on a server, comprises an insurance policy management system to ensure to stay in line with the insurance policy at least partly while performing the agricultural process. The digital service module plans and implements the service events based on an optimization strategy, which may comprise a multi-target optimization strategy based on a number of weighted optimization criteria, which may be at least partly derived from insurance policy information.

### CROSS REFERENCE TO RELATED APPLICATIONS

This application is a continuation-in-part and claims priority to PCT Application No. PCT/IB2023/061309 (published as WO/2024/165908) filed on Nov. 9, 2023, which claims priority to German Patent Application No. 10 2023 103 208.9 filed Feb. 9, 2023, the entire disclosure of both which are hereby incorporated by reference herein. This application is also related to U.S. application Ser. No. ______ (attorney docket no. 15191-24025A (P05768/8)), U.S. application Ser. No. ______ (attorney docket no. 15191-24026A (P05769/8)), U.S. application Ser. No. ______ (attorney docket no. 15191-24027A (P05770/8)), U.S. application Ser. No. ______ (attorney docket no. 15191-24028A (P05771/8)), U.S. application Ser. No. ______ (attorney docket no. 15191-24029A (P05772/8)), U.S. application Ser. No. ______ (attorney docket no. 15191-24030A (P05773/8)), and U.S. application Ser. No. ______ (attorney docket no. 15191-24032A (P05775/8)), each of which are incorporated by reference herein in their entirety.

### TECHNICAL FIELD

The present invention relates to a method and system for providing a technical service to an agricultural working machine and to a method and system for providing an insurance protection regarding the performance of an agricultural process.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Agricultural working machines may regularly need technical service, including repairs, changes of damaged and worn parts and upgrades. So far, this technical service is often done at dedicated servicing locations. A customer owning an agricultural working machine in need of such a service may then have to move the agricultural working machine to the servicing location. A service technician at the servicing location locates a technical problem, may order spare parts to fix the problem and provides the needed services to fix the problem. Afterwards, the customer may pick up the agricultural working machine.

Technical problems of agricultural working machines often occur during use and lead to a downtime of the agricultural working machine. Downtime for agricultural working machines may have significant negative impacts on farmers and agricultural operations. When a machine is unable to perform its intended tasks, it may result in decreased productivity, lost revenue, and increased operating costs. In some cases, downtime may also lead to missed deadlines for planting or harvesting crops, which may result in reduced yields and lower quality produce. Furthermore, prolonged downtime may result in additional wear and tear on the machine, which may further increase the likelihood of future breakdowns and reduce the lifespan of the equipment. Therefore, minimizing downtime is crucial for maintaining the efficient and profitable operation of agricultural businesses.

Those technical problems of the agricultural working machine, depending on their complexity, may therefore compromise the complete agricultural process and even the agricultural processes that are planned to be performed subsequently. The risk of the occurrence of a technical problem is in some cases incalculable for the customer operating the agricultural working machine.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates an overview of the disclosed method in use.

FIG. 2 illustrates an overview of the components assigned to the disclosed method.

FIG. 3 illustrates an overview of the flow of data between the components of FIG. 2.

### DETAILED DESCRIPTION

As discussed in the background, technical problems of the agricultural working machine, depending on their complexity, may compromise the complete agricultural process and even the agricultural processes that are planned to be performed subsequently. The risk of the occurrence of a technical problem may be incalculable for the customer operating the agricultural working machine. It may therefore be a challenge to support the customer who is operating the agricultural machine to handle this risk.

Thus, in one or some embodiments, the risk for the customer who is operating the agricultural machine, may be handled by applying the concept of insurance to the complete agricultural process. One idea may be to have an insurance contract with an insurance policy in place between an insurance provider (which may be the service provider) and the customer operating the agricultural working machine. According to this contract, any irregularity in the agricultural process, such as a technical problem occurring at the agricultural working machine may be managed with no additional costs by the insurance provider, as far as some or all conditions for coverage included in the insurance policy are met. As a general concept, the insurance provider may take all necessary steps to neutralize or reduce this irregularity. In one or some embodiments, the only limit is the insured maximum costs coverage the parties have previously agreed on. The most extreme measure that might have to be taken by the insurance provider (e.g., the service provider) may be the replacement of the agricultural working machine by a rental agricultural machine or an exchange agricultural machine, which may be automatically assigned. Further, responsive to automatically assigning the rental agricultural machine or the exchange agricultural machine in place of the agricultural working machine, the rental agricultural machine or the exchange agricultural machine may be automatically driven to a designated place (e.g., autonomously driving the rental agricultural machine or the exchange agricultural machine to the place where the agricultural working machine is currently positioned so that the rental agricultural machine or the exchange agricultural machine autonomously drives at least partly or entirely along the route without human intervention).

In one or some embodiments, any above-noted irregularity, such as a technical problem of the agricultural working machine, may be managed in a most effective and particularly cost minimizing manner. Responsive to the realization of an above-noted insurance concept, a tailored digital service module, which may be hosted on a server, is disclosed, which may ensure to comport with the insurance policy at least partly while performing the agricultural process. This may be of particular importance, particularly when a technical problem of the agricultural working machine occurs, which may require the provision of a technical service.

The disclosed method may rely on the digital service module automatically coordinating the intended technical service effectively based on an optimization strategy, so that the technical problem is fixed in line or comporting with the insurance policy.

The above-noted dynamic of the agricultural process in question calls for a method, which may be dynamically adjustable onto the respective task. For this, the technical services of agricultural working machines may be reorganized such that service technicians with service vehicles loaded with the right tooling and the needed parts to perform the services are orchestrated (such as automatically orchestrated) in a synchronized manner, in order to perform the service event directly at the agricultural machine on the field. The parts may arrive (e.g., automatically arrive, such as by drones or automated-driven vehicles) at the customer's location just in time (e.g., at or within a predetermined period before) or a meeting between the part runners (e.g., which may automatically arrive, such as by drones or automated-driven vehicles) and the service vehicles (e.g., which may also automatically arrive, such as by automated-driven vehicles) is arranged. This basic concept already may allow performing the service in a single run at the location that the agricultural working machine currently is at or will be at the time of the service.

In this regard, the above orchestration of the respective entities may be managed automatically by the digital service model.

To bring the requisite flexibility into the digital service module, the management of the digital service module may be based on an optimization strategy, which is a multi-target optimization strategy with a plurality of weighted optimization criteria.

Another aspect, separate from costs, may comprise a focus on time and quality. Regarding the aspect of time, it may be crucial to maintain time schedules, particularly to perform the technical service in an expected or predetermined time frame. Regarding the aspect of quality, it may be crucial to guarantee a predetermined quality level. The expression “quality level” may mean that the service may be performed with different levels of durability. A defect belt, for example, may be exchanged or replaced by a new belt, which may correspond to a maximum quality level, or may be provisionally repaired by using a special adhesive, which may correspond to a low quality level in the above noted sense.

In order to have all the necessary information needed in place, at least one server, such as a single server, may provide at least one database, such as a single database, with comprehensive data regarding the agricultural process and various, peripheral information as well. The database may also comprise or stored therein insurance policy information regarding the contents of the insurance policy. Various aspects of the insurance policy stored in the database are contemplated. For example, the insured maximum cost coverage represents the limit of costs, that may be spent for fixing technical problems of the agricultural working machine.

The insurance policy management system may automatically use the database information to parameterize the optimization strategy such that the target performance criteria are safely being met.

The resulting structure working with a specialized, particularly flexible approach to optimization with a focus on staying within the limits of an insurance policy (in combination with performing one or more automatic actions), may be enormously effective, even with the agricultural process changing during the implementation of the technical service.

In detail, a method is disclosed for performing an agricultural process in line with an insurance policy by operating an agricultural working machine by a customer, wherein a digital service module, which may be hosted on at least one server, comprises an insurance policy management system to ensure to stay in line or comport with the insurance policy during performing the agricultural process. The occurrence of a technical problem of the agricultural machine may require the provision of a technical service to the agricultural working machine, which is to be performed in line with the insurance policy. For coordinating the technical service, the digital service module may receive a request for service at least partly during performing the agricultural process, with the request for service including a problem description regarding a technical problem of the agricultural working machine. The system may comprise at least one database, whether included in the at least one server or whether the at least one database works with the server. The database may store various information, such as information regarding any one, any combination, or all of: about the agricultural process; location of the agricultural working machine; locations of spare parts for the agricultural working machine; transport devices such as part runners for the transport of parts and service vehicles comprising tools for servicing the agricultural working machine; service technicians; or information insurance policy information.

Information insurance policy information may include any one, any combination, or all of: insured target performance criteria; insured incidents within the agricultural process; insured maximum costs coverage; or insurance requirements to the customer. The spare parts may include parts which are located in service vehicles or which are located at central storages,

In one or some embodiments, the digital service module comprises a data analytics system automatically deriving service event(s) from the request for service (alternatively termed a service request), with the service event(s) including any one, any combination, or all of: the services needed to fix the problem of the agricultural working machine; the needed service technician; the needed tools; and the needed spare parts. In one or some embodiments, the digital service module automatically plans and automatically implements the service events based on an optimization strategy, wherein the optimization strategy may be a multi-target optimization strategy based on a number of weighted optimization criteria. The insurance policy management system may automatically derive a plurality of optimization criteria for the optimization strategy from the insurance policy information, with the plurality of optimization criteria being weighted and may include one or both of: achieving the insured target performance criteria; keeping the costs for a respective service event under the insured maximum costs coverage.

The ability to optimize the management performed by the digital service module, not in a standardized manner, but in a highly tailored and individualized manner, may make the management process extremely complex. To reduce complexity, the digital service module may be structured into a central management system and subsystems such as a route management system, a spare parts management system and a technician management system.

In one or some embodiments, the central management system may automatically coordinate the route management system, the spare parts management system and the technician management system by realizing an information cycle, which may be followed by an optimizing cycle and an implementation cycle. In one or some embodiments, the central management system may well switch from the implementation cycle back to the optimizing cycle, if it turns out, that the real implementation does not meet the optimization criteria defined in the optimization strategy. In this regard, the cycles may be automatically and iteratively performed. This may lead to an ongoing automated optimization, even during the implementation with accordingly good optimization results.

The completion time regarding a service event may play an important role in any situation in which a technical problem of the agricultural working machine occurs. Thus, the corresponding optimization criteria may be highly weighted within the optimization strategy.

In one or some embodiments, a repair may not meet the optimization criteria, such as, for example, the optimization criteria not being met in terms of time and/or quality. In this case, the insurance policy may allow the replacement of the agricultural machine, as long as this is in line with the insured maximum costs coverage. With this fallback strategy, any technical problem may appear to be fixable, without the customer having to bear the financial risk of such irregularity. In this regard, the replacement of the agricultural machine on a temporary basis may be performed (such as autonomously driving the replacement agricultural machine to the customer's designated location for use by the customer while the customer's agricultural machine is being repaired and/or autonomously driving the replacement agricultural machine from the customer's designated location to another designated location after the customer's agricultural machine is repaired).

In one or some embodiments, with regard to the insurance, the insurance policy may include certain conditions under which an insurance coverage is possible. For example, the customer should generally treat and service the agricultural working machine adequately in order not to cause any malfunction. Responsive to identifying (such as automatically identifying based on automatic analysis of repair records) the customer being in breach of the insurance policy, this may be documented and stored in the database as a basis for the discussion with the customer (e.g., responsive to automatically identifying the failure to adequately service, the system may automatically send a communication to the customer indicating the failure for discussion).

Also, the insurance policy management system may automatically evaluate responsive to automatically determining that the technical problem to be fixed is to be counted to the insured incidents according to the insurance policy. Again this may be a basis for a discussion with the customer.

Depending on the result of the one or more audit cycle(s), the insurance policy management system may automatically perform an insurance refusal cycle (e.g., responsive to automatically determining that at least one of the audit results is/are negative). In the refusal cycle, the insurance policy management system may automatically notify the customer about the audit result.

In one or some embodiments, one, some or each of the route management system, the spare parts management system and the technician management system, may on implementation request, automatically perform detailed planning cycles. This may mean that the central management system automatically provides the basic guideline for implementation with its implementation requests, while the subsystems, on this basis, may automatically perform the detailed planning. This centralized rough planning and decentralized fine planning may lead to an exceptionally effective planning process.

For providing a technical service as noted above, it may be of utmost importance to provide the customer with a realistic time estimation of the starting time of the service event and to take some or all actions necessary to keep this promise to the customer without delay. Therefore, this delay may be defined as an optimization criterion of the optimization strategy in order to reduce or minimize delay of an actual starting time for the at least one service event with respect to the starting time that is estimated.

In one or some embodiments, an urgency level for the service event may be automatically derived by the central management system from the information about the agricultural process, which may be stored in the database. This may mean that changes in the agricultural process, for example changes in the agricultural working machine, changes in weather, and/or changes within the harvest, may automatically lead to a change of the urgency level, which may comprise one of the plurality of optimization criteria.

In one or some embodiments, automatically identifying a change in the agricultural process may lead to an automatic change in the weighting of the optimization criteria. In this regard, the optimization may be automatically adapted to the agricultural process with its above noted dynamics.

The optimization cycle may rely on prediction information, wherein the prediction information may be derived from local and/or global historical data and/or on local and/or global live information. Certain local conditions may lead to certain machine defects, which may be automatically predicted based on local historical data. This prediction information may help to further optimize the service event.

In one or some embodiments, the route management system may be central to the optimization strategy. For example, changes in the route planning may automatically trigger changes in the optimization result.

In one or some embodiments, a method for providing an insurance protection regarding the performance of an agricultural process is disclosed. The agricultural process is performed by a customer operating an agricultural working machine. An insurance agreement with an insurance policy may be reached between an insurance provider and the customer, wherein the insurance provider performs service event(s) within the insurance policy that may ensure the completion of the agricultural process within a predetermined time and/or within a predetermined quality.

With the disclosed insurance protection, the insurance provider, who may be the service provider for the service events to be performed or the manufacturer of the agricultural working machine, may take some or all of the necessary steps to guarantee the completion of the agricultural process within a predetermined time and/or within a predetermined quality. This may mean that the insurance provider pro-actively takes all necessary steps to keep the agricultural working machine functioning within the agricultural process.

In one or some embodiments, all the customer has to do is to pay the insurance premium and to comply with the conditions set down in the insurance contract. The customer is free from any above-noted risk due to unplannable irregularities. The customer does not have to reserve any financial resources for those irregularities and may invest those financial resources into other projects, such as other agricultural processes. In case, the insurance provider is the manufacturer of the agricultural working machine, this insurance concept may also increase the goodwill and trust of the customer in the technology of the manufacturer.

In one or some embodiments, the disclosed method may rely on a digital service module as discussed herein. This may be particularly important for the insurance provider. Because in order to economically make sense also to the insurance provider (e.g., the manufacturer of the agricultural working machine), any functional problem has to be fixed with maximum efficiency regarding time and costs.

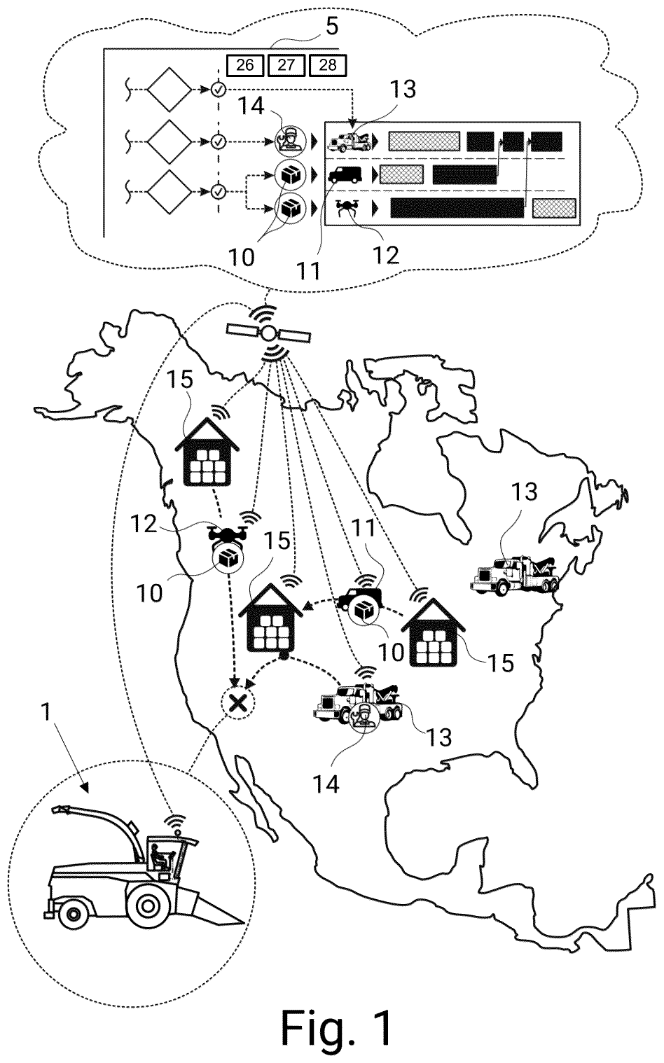

Referring to the figures, FIG. 1 illustrates how an agricultural working machine 1 may be operated and serviced according to the disclosed system and method. In FIG. 1, a technical service has been planned for the shown agricultural working machine 1 marked with an “X”. The technical service may have been planned by a digital service module 2 which is explained below.

The disclosed method is directed to automatically performing an agricultural process in line or to comport with an insurance policy by automatically operating an agricultural working machine 1 by a customer 3. The insurance policy may make it possible for the customer 3 to safely meet certain optimization criteria 4 regarding the agricultural process, even if this takes unplanned resources that the customer 3 could at least momentarily not afford.

The agricultural process may comprise a harvesting process, a soil cultivation process or the like. In the following description, as an example the agricultural process is a crop harvesting process, which is being performed by a combine. Other processing relating to agriculture is contemplated.

The digital service module 2 may be hosted on at least one server (such as a server 5) and may comprise an insurance policy management system 6 configured to automatically ensure to stay in line or comport with the insurance policy at least partly during automatically performing the agricultural process. The insurance policy management may ensure that the agricultural process is being performed according to the intention of the insurance policy. In detail, the insurance policy management system 6 may be configured to automatically set predetermined optimization criteria (e.g., the right optimization criteria 4) and to automatically audit if the customer 3 is complying with the insurance policy.

In one or some embodiments, the server 5 may comprise computing and communication functionality, such as it may include at least one processor 26, at least one memory 27, and at least one communication interface 28. The at least one processor 26 and at least one memory 27 may be in communication (e.g., wired and/or wirelessly) with one another. In one or some embodiments, the processor 26 may comprise a microprocessor, controller, PLA, or the like. Similarly, the memory 27 may comprise any type of storage device (e.g., any type of memory). Though the processor 26 and the memory 27 are depicted as separate elements, they may be part of a single machine, which includes a microprocessor (or other type of controller) and a memory. Alternatively, the processor 26 may rely on the memory 27 for all of its memory needs. Still alternatively, the processor 26 may rely on a database (such as database 6) for some or all of its memory needs.

The memory 27 may comprise a tangible computer-readable medium that include software that, when executed by the processor 26 is configured to perform any one, any combination, or all of the functionality described herein, such as one or more parts of the digital service module 3. In this regard, any functionality described herein, such as (without limitation) with regard to the insurance policy management system 6, the route management system 17, the spare parts management system 18, the technician management system 19, the central management system 20, the drone 12, the service vehicle 13, the prediction management system 22, customer (via a laptop computer, a smartphone, tablet or the like that includes a user interface, such as a touchscreen), or service technician (via a laptop computer, a smartphone, tablet or the like that includes a user interface, such as a touchscreen) may use the computing functionality described herein, such as the processor 26, the memory 27 and/or the communication interface 28.

Further, the communication interface 28 may be configured to communicate (e.g., wired and/or wirelessly) with one or more electronic devices, such as disclosed herein as known by one of skill in the art.

The processor 26 and the memory 27 are merely one example of a computational configuration for the electronic devices discussed herein. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

In one or some embodiments, the occurrence of a technical problem of the agricultural machine may require the provision of a technical service to the agricultural working machine 1. This technical service may be performed in line with the insurance policy, as will be explained below.

The server 5, which the digital service module 2 may be hosted on, may comprises at least one database (e.g., a database 7). The digital service module 2 may be configured to automatically coordinate a technical service for the agricultural working machine 1. Again as an example, the agricultural working machine 1 may manifest a technical problem due to unusual squeaking sounds from the threshing unit of the combine. Other technical problems are contemplated.

First, the digital service module 2 of the server 5 may receive a request for service 8 at least partly during performing the agricultural process. This request may be made by the customer 3, for example via a customer support 9, or by the agricultural working machine 1 itself via a communication module (e.g., the request may be via a manual input and/or via an automatic communication transmitted by the agricultural working machine 1 itself). In one or some embodiments, the communications may be wired and/or wireless, such as internet-based communication.

In one or some embodiments, the request for service 8 may be made during the agricultural process. This may be, depending on the machine problem, while the agricultural working machine 1 is still running and performing the agricultural process. The request for service 8 may include a problem description regarding a technical problem of the agricultural working machine 1. This problem description may include explicitly the service event to be performed including the necessary resources for fixing the problem. The problem description, however, may also be a description of the machine problem in natural language, for example: “The threshing unit produces squeaking sounds”.

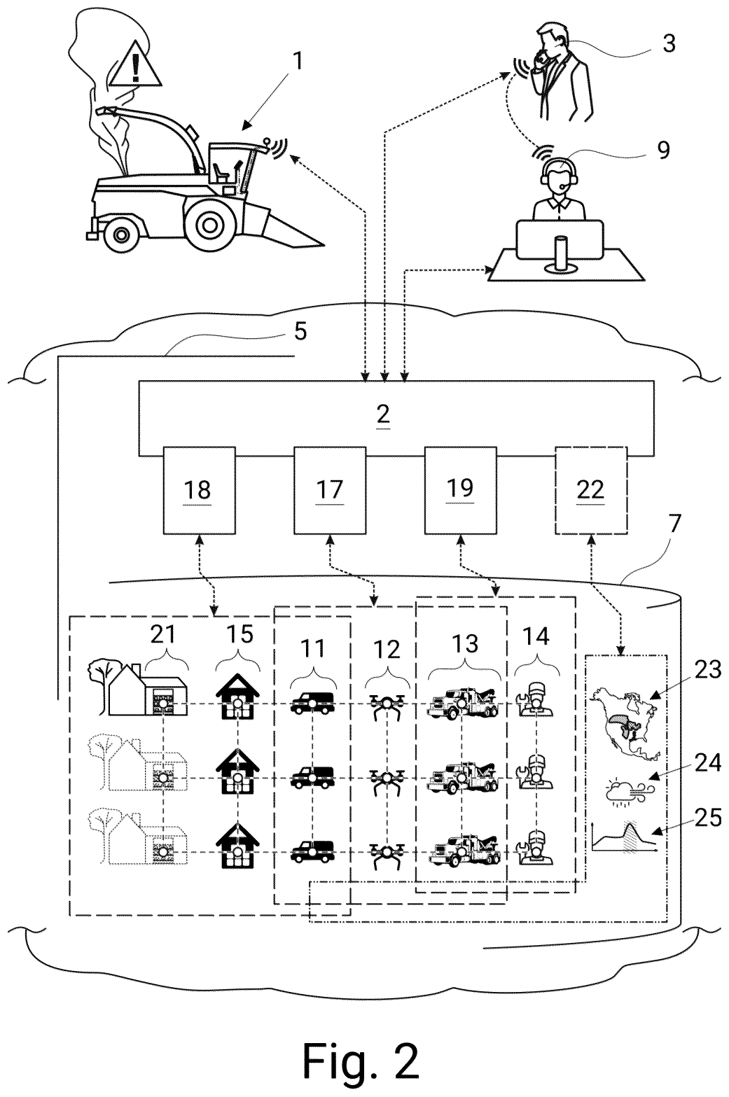

As noted above and shown in FIG. 2, the server 5 may comprise a database 7, wherein in the database 7 information about any one, any combination, or all of the agricultural process, the location of the agricultural working machine 1, locations of spare parts 10 for the agricultural working machine 1, information about transport devices such as part runners 11 or drones 12 for the transport of parts and service vehicles 13 comprising tools for servicing the agricultural working machine 1, and/or information about service technicians 14 may be stored. In addition, insurance policy information may be stored in the database 7. This insurance policy information may include any one, any combination, or all of the: insured target performance criteria; insured incidents within the agricultural process; insured maximum costs coverage; or insurance requirements to the customer 3.

The information about the agricultural process may include information regarding any one, any combination, or all of the harvest, the crop, the soil or the like, technical information about the agricultural working machine 1 and/or weather information. A typical information about the agricultural process may be the work progress with regard to the harvest of a field, the change of the characteristic of the agricultural working machine 1, which in the example may be the increase of the squeaking noise, or an approaching front carrying rain.

The “insured target performance criteria” may represent those performance criteria, that are guaranteed, as long as they may be realized with costs within the “insured maximum costs coverage”. The “insured incidents within the agricultural process” may represent those irregularities and in particular potential technical problems of the agricultural working machine 1, which fixing may be covered by the insurance, as long as this fixing may be realized with costs within the “insured maximum costs coverage”.

The “insurance requirements to the customer” may describe the conditions, under which an insurance coverage is possible, particularly in view of how the customer 3 has treated the agricultural working machine 1.

Accordingly, the insurance policy information may include at least the above noted basic information regarding the insurance contract. It may, however, include more detailed information about which scenarios are being insured and which maximum costs coverage may be guaranteed for each scenario.

Often, a problem of the agricultural working machine 1 may require the exchange of spare parts 10 like a belt, a valve, a hydraulic pump, electronic components or the like. Those spare parts 10 may be located in service vehicles 13, at central storages 15 or the like.

The digital service module 2 may comprise a data analytics system 16 automatically deriving service events from the request for service 8. Those service events may include any one, any combination, or all of: the services needed to fix the problem of the agricultural working machine 1; the needed service technician 14; the needed tools; or needed spare parts 10. The data analytics system 16 may comprise a simple rule-based system to extract the information about the necessary service event from the request for service 8. Alternatively, the data analytics system 16 may comprise an AI-based system, that is trained to handle natural language input. As a result, a service event, which is to be performed at the agricultural working machine 1, may be defined any one, any combination or all of: the services needed to fix the problem of the agricultural working machine 1; the needed service technician 14; the needed tools; or the needed spare parts 10 as noted above.

In one or some embodiments, the optimization strategy comprises a multi-target optimization strategy based on a number of weighted optimization criteria 4, as will be noted below.

In one or some embodiments, the optimization criteria 4 may be dynamically and automatically changed during the implementation of the service event, for example, if aspects of the agricultural process have changed radically. In this regard, analysis of the aspects of the agricultural process may be automatically analyzed for change greater than a predetermined metric; responsive to automatic determination that the agricultural process has changed greater than a predetermined metric, the optimization criteria 4 may be dynamically and automatically changed during the implementation of the service event. For example, one aspect subject to automatic analysis may comprise a weather change, which may make the optimization criteria 4 “minimize reaction time between service request and starting time of the service event the top priority, while the optimization criteria 4 “Minimize costs for the service event” be a lower priority.

The insurance policy management system 6 may automatically derive optimization criteria 4 for the optimization strategy from the insurance policy information, wherein those optimization criteria 4, that may be highly weighted, may be one or both of: achieve the insured target performance criteria; or keep the costs for a service event under the insured maximum costs coverage.

The disclosed method may automatically make sure that all resources for the service event are present within a predetermined amount of time at the agricultural working machine 1. In order to achieve this task, the digital service module 2 may comprise:
a route management system 17 configured to automatically planning and automatically implement the routes of transport devices for transporting spare parts 10, tools and service technicians 14 (e.g., drones and/or self-driving vehicles may automatically import the determined routes from the route management system 17 in order to automatically transport the spare parts 10, the tools, and/or the service technicians 14 to the designated site).
a spare parts management system 18 configured to automatically plan and automatically implement the availability of the spare parts 10 in parts storage devices such as warehouses, vehicles, or the like (e.g., drones and/or self-driving vehicles may automatically transport the spare parts 10 to the parts storage devices).
a technician management system 19 configured to automatically plan and automatically implement the availability of service technicians 14 (e.g., self-driving vehicles may automatically transport the service technicians 14 to the designated site).

In other words, the complex task of automatically providing one, some or all of those resources from different locations to the agricultural working machine 1 within a predefined timescale, may be performed at least partially de-centrally by one, some or all of route management system 17, spare parts management system 18, or the technician management system 19.

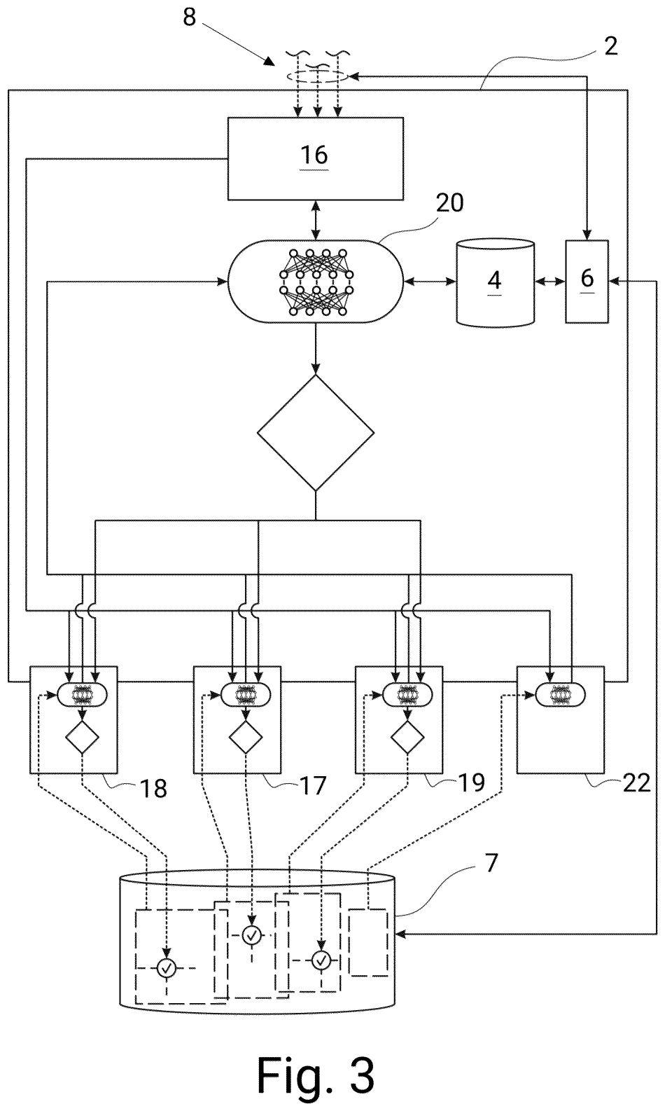

The digital service module 2 may further comprise a central management system 20 automatically coordinating those subsystems, namely one or more of the route management system 17, the spare parts management system 18 and the technician management system 19 for automatically planning and automatically implementing the service events based on an optimization strategy. This is indicated in FIG. 2 and FIG. 3.

An example sequence of events is shown in FIG. 3. After the receipt of the request for service 8, the central management system 20 may automatically coordinate the route management system 17, the spare parts management system 18 and the technician management system 19 based on the optimization strategy.

As a first step, this may be performed by the central management system 20 in an information cycle, automatically sending information requests to the technician management system 19, the spare parts management system 18 and the route management system 17 to automatically retrieve information about the locations and availability of instances of the needed service technician 14, of the needed tools and of the needed spare parts 10 and to automatically retrieve information about possible routes for transport devices to directly or indirectly transport the instances to the location of the service event.

In one or some embodiments, the expressions “service technician” 14, “tools”, “spare parts” and “transport devices” may represent not the actual existing component, but the type a component. An “instance” of the respective component may represent the actual existing component. If, for example, the central management system 20 may automatically derive that the service event requires a belt as a spare part 10, then this means just the type of the spare part 10, namely a belt with a certain product number. The instance of the belt, however, may be the belt actually being present in one or more storage locations such as a central storage 15 or even a service vehicle 13.

Subsequently, the central management system 20 may automatically perform an optimization cycle based on the optimization strategy, in which it automatically identifies the respective instances and desired relocation requirements for at least part of those instances and the resulting routes for transportation devices and automatically generates a time schedule for the implementation. In one or some embodiments, the instances of all resources needed are available and stored in a convenient location (e.g., a predetermined location within a predetermined distance). Statistically, however, there is a probability that, for example, the instance of a needed spare part 10 is not available nearby (e.g., greater than a predetermined distance) the agricultural working machine 1 in a central storage 15 or warehouse or at a local stock at farm 21, such that a relocation of the spare part 10 has to be initiated. For this, the central management system 20 may automatically plan the relocation of the respective resource and may automatically control the transport (e.g., via drone, self-driving vehicle, or the like).

Based on the results of the optimization cycle, in an implementation cycle, the central management system 20 may automatically forward implementation requests including the identified instances, routes for transportation devices and a time schedule to the technician management system 19, the spare parts management system 18 and the route management system 17.

Finally, based on the implementation tasks, the technician management system 19, the spare parts management system 18 and the route management system 17 may automatically implement the time schedule by automatically sending execution requests to the instances of the needed service technician 14, of the needed tools, of the parts storage devices and to the transport devices assigned to the identified routes (and execution requests for automatic transport, such as via drone and/or self-driving vehicle). In the course of this implementation, the subsystems may automatically perform a decentralized planning of the implementation request. This may include the communication (e.g., wired and/or wireless) between the subsystems in order to further automatically optimize the sequence of actions regarding the above-noted optimization strategy. This may regard particularly with respect to the route management system 17, which may automatically coordinate the transport of all resources and may iteratively and automatically generate and assess route alternatives in view of the optimization strategy.

In one or some embodiments, optimization criteria 4, which may be an insured target performance criteria in the above-noted sense and which may be highly weighted, is the completion of the service event within a predetermined completion time. If this target performance criteria is part of the insurance policy, it may be guaranteed to the customer 3 that the predetermined completion time is met as long as this is in line with the insured maximum costs coverage.

In the event that the optimization criteria 4 may not be met due to the complexity of the technical problem, the agricultural working machine 1 may be replaced by a rental machine or an exchange machine. This replacement may be automatically managed by the digital service module 2 as a specialized service event. Again this replacement may be possible if this is in line with the insured maximum costs coverage.

In order to automatically audit the compliance with the insurance agreement, in an audit cycle, the insurance policy management system 6 may automatically evaluate whether the insurance requirements to the customer 3 are met by the way that the customer 3 has been operating the agricultural working machine 1 and stores the audit result in the database 7.

According to another audit cycle regarding the compliance with the insurance agreement, the insurance requirements to the customer 3 may include forbidden modes of operation for the agricultural working machine 1 and that in the audit cycle, the insurance policy management system 6 may automatically evaluate whether the agricultural working machine 1 has been operated in a forbidden mode of operation. For example, the insurance policy management system 6 may automatically communicate with the agricultural working machine 1 in order to automatically assess whether the agricultural working machine 1 has been operated in the forbidden mode of operation. Responsive to the communication, the insurance policy management system 6 may automatically make the determination as to whether the agricultural working machine 1 has been operated in the forbidden mode of operation. Thus, this may be important as the insurance coverage may only be guaranteed if the customer 3, for example, did not overstress or badly service the agricultural working machine 1. Again, the determination as to overstressing may be automatically made based on automatic analysis of the information in or regarding agricultural working machine 1 (e.g., operational information resident in the agricultural working machine 1 and/or service information resident in the agricultural working machine 1) and/or based on automatic analysis of service records.

In one or some embodiments, in an audit cycle, the insurance policy management system 6 may automatically evaluate whether the service event, which is being planned by the digital service module 2, is to be counted to the insured incidents within the agricultural process and automatically store the result in the database 7.

In case of a negative audit result in an audit cycle, the insurance policy management system 6 may automatically perform an insurance refusal cycle. Within this insurance refusal cycle, the insurance policy management system 6 may automatically remove those optimization criteria 4 that have been generated based on the insurance policy information from the optimization strategy. In those cases, the customer 3 may be automatically informed accordingly via the customer support 9 or the like.

As also noted above, one focus is to manage the service events with respect to time. In one or some embodiments, the route management system 17 automatically generate an estimation of the starting time for the service event at the agricultural working machine 1, that the central management system 20 automatically forwards this planned estimated starting time to the customer 3 and that another optimization criteria 4 for the optimization strategy may be “Minimizing the delay of the starting time for the service event with respect to the planned starting time”. This may mean that any deviation from the planned starting time is to be prevented. This additional optimization criteria 4 may be considered a high or low priority depending on the optimization strategy.

For the effective planning of the service event, in one or some embodiments, an indication for the urgency for having the machine problem is solved. Therefore, the central management system 20 may automatically derive an urgency indication from the customer 3 and/or from the information about the agricultural process stored in the database 7, for example depending on increasing wear of other aggregates or other parts of the agricultural machine induced by the problem to be solved by the service event. As another optimization criteria 4, the urgency lever, either set by the customer 3 and/or automatically set from within the agricultural process, may be defined. In the latter case, rules may be stored in the central management system 20 in order to automatically derive the respective urgency level.

In one or some embodiments, each optimization criteria 4 is automatically weighted within the optimization strategy such that each optimization criteria 4 is automatically assigned a respective priority value, which may be changed (such as dynamically changed) in the course of or at least partly during the implementation of the service event based on a customer 3 request and/or based on a change of the agricultural process. The change of the agricultural process may be any change that increases or decreases the urgency to solve the machine problem. Based on this priority value for each optimization criteria 4, the multi-target optimization strategy may be executed.

According to the above, the expression “highly weighted” may mean that the priority value is correspondingly high. In one or some embodiments, a prediction information may be derived by a prediction management system 22 shown in FIG. 2. The prediction management system 22 may automatically generate prediction information regarding any one, any combination, or all of regional cultivation and harvesting characteristics, regional climate/weather characteristics, and/or regional soil characteristics and/or regional technical failure expectations based on regional data 23, weather data 24 and seasonal data 25 in combination with local and global live information and that the prediction information may be taken into account during the optimization cycle. In one or some embodiments, some or all of this information may help to automatically manage the service event. For example, the cultivation and harvesting information may include information about the usual kind of crop being cultivated and the usual time of harvest during the year, which information may be used during optimization cycle, even if this information has not been forwarded by the customer 3. The usual weather characteristics may again be regarded in the optimization cycle, in order to automatically estimate whether minimizing the time needed to fix the machine problem is of high or lower priority.

In one or some embodiments, the route management system 17, on implementation task, may automatically generate routes of transport devices to orchestrate the transport of instances of needed service technicians 14 and needed spare parts 10 to the agricultural working machine 1 to be serviced (e.g., via drones and/or self-driving vehicles) and automatically transmit requests for execution to the respective transport devices, taking into account at least the optimization criteria 4, such as one or both of: reducing (or minimizing) reaction time between service request and starting time of the service event; or reducing (or minimizing) waiting time of the service technician 14 for spare parts 10 at the agricultural working machine 1.

Especially regarding the execution of routes by transport devices, numerous influences may be present to compromise meeting the time schedule. As such, in one or some embodiments, the route management system 17 may automatically monitor the actual execution of the routes of transport devices and identifies deviations from the time schedule (e.g., automatically monitor via GPS feed from the transport devices to determine whether the deviation is greater than a predetermined amount of time), and depending on the degree of deviation (e.g., greater than the predetermined amount of time), perform one or both of: automatically modifying the routes to meet the time schedule and automatically transmitting a request for execution of the new routes by the respective transport devices; or automatically sending a change request to the central management system 20 to perform an optimization cycle to generate a new implementation request.

The spare parts management system 18 may be responsible for the availability of any spare parts 10 needed for performing the service event. In one or some embodiments, the spare parts management system 18 may automatically perform any one, any combination, or all of: automatically monitoring the locations and availability of instances of spare parts 10 and automatically providing this information into the database 7 (e.g., automatic determination of stocks of spare part(s) 10); automatically organizing a predetermined inventory of spare parts 10 in storage devices such as central storages 15 by transmitting transport requests to the route management system 17; on an implementation request by the central management system 20 automatically organizing the availability of certain instances of spare parts 10 by transmitting a transport request to the route management system 17 (e.g., automatically controlling drone or self-driving vehicles in order to transport the requested spare parts 10); or on an implementation request by the central management system 20, automatically organize a handover of certain instances of spare parts 10 at a predetermined location (e.g., automatically controlling drone or self-driving vehicles in order to transport the requested spare parts 10 to the predetermined location).

The technician management system 19 may be responsible for the availability of service technicians 14 and their respective qualification. In one or some embodiments, the technician management system 19 may automatically perform any one, any combination, or all of: automatically monitoring the locations and availability of instances of service technicians 14 and the respective qualification and automatically transmit this information into the database 7 (e.g., automatically monitor current GPS location in real time); automatically organize a predetermined distribution of qualification of service technicians 14 by automatically transmitting transport requests to the route management system 17 and/or to the instance of the service technician 14; or on an implementation request by the central management system 20, automatically organize the availability of certain instances of service technicians 14 by transmitting a transport request to the route management system 17 and/or to the instance of the service technician (e.g., automatically controlling drone or self-driving vehicles in order to transport the service technician(s)).

According to the above, various communication and data exchange may take place between the customer 3, the service technicians 14, the digital service module 2 the transport devices, the storage devices and the agricultural working machine 1, as is indicated in the drawings. For this, those entities may be assigned respective communication interfaces.

Moreover, the agricultural working machine 1 may be provided with one or more sensors to detect the state of the machine and the respective mode of operation. This information may be retrieved by the digital service module 2 as noted above. The same may apply to the transport devices and the storage devices. The customer 3 and the service technicians 14 may be assigned communication devices such as smartphones.

In one or some embodiments, a method for providing an insurance protection regarding the performance of an agricultural process is disclosed, in which the agricultural process is performed by a customer 3 operating an agricultural working machine 1. The insurance agreement with an insurance policy may be reached between an insurance provider and the customer 3, wherein the insurance provider may perform service events within the insurance policy that may ensure the completion of the agricultural process within a predetermined time and/or within a predetermined quality.

In one or some embodiments, a digital service module 2 on a server 5 is configured to perform the agricultural process as described above. All explanations discussed herein may be applied to the disclosed method.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage

### LIST OF REFERENCE NUMBERS

1 agricultural working machine
2 digital service module
3 customer
4 optimization criteria
5 server
6 insurance policy management system
7 database
8 request for service
9 customer support
10 spare part
11 part runner
12 drone
13 service vehicle
14 service technician
15 central storage
16 data analytics system
17 route management system
18 spare parts management system
19 technician management system
20 central management system
21 local stock at farm
22 prediction management system
23 regional data
24 weather data
25 seasonal data
26 processor
27 memory
28 communication interface

1. A method for automatically managing an agricultural process responsive to an insurance policy by automatically operating an agricultural working machine by a customer, the method comprising:
receiving a service request at least partly during performing the agricultural process, the request for service including a problem description regarding a technical problem of the agricultural working machine;
responsive to receiving the service request:
automatically accessing agricultural information about one or more of: the agricultural process; location of the agricultural working machine; at least one location of one or more spare parts for the agricultural working machine; at least one transport device for the transport of the one or more spare parts; or at least one service vehicle comprising tools for servicing the agricultural working machine;
automatically accessing insurance policy information including one or more of: insured target performance criteria; insured incidents within the agricultural process; insured maximum costs coverage; or insurance requirements to the customer;
automatically determining, based on analysis by a data analytics system of the agricultural information accessed and the service request, at least one service event comprising: one or more services to perform to fix the technical problem of the agricultural working machine; one or more service technicians to perform the one or more services; one or more tools used to fix the technical problem of the agricultural working machine; and one or more respective spare parts to fix the technical problem of the agricultural working machine; and
automatically planning and implementing, using a multi-target optimization strategy based on a plurality of weighted optimization criteria, the at least one service event, wherein automatically planning and implementing the at least one service event includes automatically transporting the one or more respective spare parts from one or more service vehicles or from one or more central storage warehouses to a location of the agricultural working machine; and
wherein the plurality of weighted optimization criteria comprise achieving the insured target performance criteria and keeping costs for the at least one service event under the insured maximum costs coverage.

2. The method of claim 1, wherein a digital service module automatically plans and implements the at least one service event and comprises:
a route management system automatically planning and implementing one or more routes of one or more transport devices for automatically transporting one or more of: the one or more respective spare parts; the one or more tools; and the one or more service technicians;
a spare parts management system automatically planning and implementing availability of the one or more respective spare parts in one or more storage locations;
a technician management system automatically planning and implementing availability of one or more service technicians;
a central management system coordinating the route management system, the spare parts management system and the technician management system for planning and implementing the at least one service event based on an optimization strategy defined by the plurality of weighted optimization criteria.

3. The method of claim 2, wherein responsive to receipt of the service request, the central management system coordinates the route management system, the spare parts management system and the technician management system based on the optimization strategy by:
in an information cycle, sending one or more information requests to the technician management system, the spare parts management system and the route management system to retrieve:
the information about locations and availability of the one or more service technicians, of the one or more tools used to fix the technical problem of the agricultural working machine, and of the one or more respective spare parts; and
the information about possible routes for the at least one transport device to directly or indirectly transport the one or more service technicians to the location of the service event;
in an optimization cycle based on the optimization strategy, identifying respective instances and desired relocation requirements for at least part of those instances and resulting routes for transportation devices and automatically generating a time schedule for the implementation;
in an implementation cycle, forwarding implementation requests including the identified respective instances, routes for transportation devices and a time schedule to the technician management system, the spare parts management system and the route management system;
based on the implementation requests, the technician management system, the spare parts management system and the route management system implementing the time schedule by sending execution requests to the instances of a needed service technician, of needed tools, of parts storage devices and to the transport devices assigned to identified routes.

4. The method of claim 1, wherein the plurality of weighted optimization criteria comprise completion of the at least one service event within a predetermined completion time.

5. The method of claim 1, wherein, responsive to automatically determining that the plurality of the weighted optimization criteria has not been met due to complexity of the technical problem, automatically assigning a rental agricultural machine or an exchange agricultural machine in place of the agricultural working machine.

6. The method of claim 5, wherein, responsive to automatically assigning the rental agricultural machine or the exchange agricultural machine in place of the agricultural working machine, automatically driving the rental agricultural machine or the exchange agricultural machine to a designated place.

7. The method of claim 1, wherein, in an audit cycle, an insurance policy management system:
automatically analyzes one or more aspects of operation of the agricultural working machine by a consumer;
automatically evaluates whether the insurance requirements to the customer are met based on the automatic analysis of the one or more aspects of operation of the agricultural working machine by the consumer; and
automatically stores the evaluation in a database.

8. The method of claim 7, wherein the insurance requirements to the customer include one or more forbidden modes of operation for the agricultural working machine; and
wherein, in the audit cycle, the insurance policy management system automatically evaluates whether the agricultural working machine has been operated in the one or more forbidden modes of operation.

9. The method of claim 8, wherein, in the audit cycle, the insurance policy management system automatically evaluates whether the at least one service event, which is being planned by a digital service module, is to be counted to the insured incidents within the agricultural process and stores the evaluation in the database.

10. The method of claim 9, wherein, responsive to the automatic evaluation determining that the agricultural working machine has been operated in the one or more forbidden modes of operation, the insurance policy management system automatically performs an insurance refusal cycle that includes automatic notice to the consumer.

11. The method of claim 1, wherein a route management system automatically generates an estimation of starting time for the at least one service event at the agricultural working machine;
wherein a central management system automatically forwards the starting time to the customer; and
wherein the plurality of weighted optimization criteria for the optimization strategy further includes minimizing delay of an actual starting time for the at least one service event with respect to the starting time that is estimated.

12. The method of claim 1, wherein a central management system automatically derives an urgency indication from one or both of the customer or from the agricultural information about the agricultural process stored in a database including information indicative of increasing wear of one or more other parts of the agricultural working machine induced by the problem to be solved by the service event; and
wherein the plurality of weighted optimization criteria further comprise: urgency level set by the customer; and the urgency level set from within the agricultural process.

13. The method of claim 1, wherein each of the plurality of weighted optimization criteria is automatically weighted within the optimization strategy such that each of the plurality of weighted optimization criteria is assigned a respective priority value; and
wherein responsive to one or both of a customer request or a change of the agricultural process, one or more of the plurality of weighted optimization criteria is dynamically changed at least partly during implementation of the at least one service event.

14. The method of claim 1, wherein a digital service module further comprises a prediction management system that:
automatically accesses regional data, weather data, seasonal data, and local and global live information; and
automatically generates, during an optimization cycle and based on the regional data, the weather data, the seasonal data, and the local and the global live information, prediction information regarding one or more of: regional cultivation and harvesting characteristics; regional climate and weather characteristics; regional soil characteristics; or regional technical failure expectations.

15. The method of claim 1, wherein a route management system, on implementation request, automatically generates one or more routes of one or more transport devices to orchestrate the transport of instances of needed service technicians and needed spare parts to the agricultural working machine to be serviced and automatically transmits one or more requests for execution to the one or more transport devices, taking into account a plurality of optimization criteria comprising: minimize reaction time between service request and starting time of the at least one service event; and minimize waiting time of the one or more service technicians for the one or more spare parts at the agricultural working machine.

16. The method of claim 1, wherein a route management system automatically monitors actual execution of one or more routes of one or more transport devices and automatically identifies one or more deviations from an estimated time schedule; and
responsive to determining the one or more deviations are greater than a predetermined amount, the route management system automatically:
modifies the one or more routes to generate one or more new routes to more closely meet the estimated time schedule and automatically transmits a request for execution of the one or more new routes by the one or more transport devices; and
sends a change request to a central management system to perform an optimization cycle to generate a new implementation request.

17. The method of claim 1, wherein a spare parts management system automatically:
monitors the locations and availability of instances of one or more spare parts;
saves the monitoring into a database;
organizes a predetermined inventory of spare parts in in one or more storage locations by transmitting transport requests to a route management system;
responsive to an implementation request by a central management system, organizes the availability of certain instances of the spare parts by transmitting a transport request to the route management system; and
responsive to an implementation request by the central management system, organizes a handover of the certain instances of spare parts at a predefined location.

18. The method of claim 1, wherein a technician management system automatically:
monitors the locations and availability of instances of one or more service technicians and the respective qualification;
stores the locations and the availability in a database;
organizes a predetermined distribution of qualification of service technicians by transmitting transport requests to one or both of a route management system or to the instance of the service technician;
responsive to an implementation request by a central management system, organizes the availability of certain instances of service technicians by automatically transmitting a transport request to one or both of the route management system or to the instance of the service technician.

19. A method for providing insurance protection regarding performance of an agricultural process, the method comprising:
performing, by a customer, the agricultural process by operating an agricultural working machine;
automatically reaching an insurance agreement with an insurance policy between an insurance provider and the customer; and
wherein the insurance provider performs one or more service events within the insurance agreement that ensure completion of the agricultural process within one or both of a predetermined time or within a predetermined quality.

20. The method of claim 19, wherein a digital service module on at least one server automatically performs:
receives at least one service request that includes a problem description regarding a technical problem of the agricultural working machine;
derives at least one service event from the at least one service request, with the at least one service event including services to fix the problem of the agricultural working machine, one or more service technician, one or more tools for fixing the problem, and one or more spare parts for fixing the agricultural working machine; and
plans and implements the at least one service event based on an optimization strategy.
